(19) United States
(12) Patent Application Publication
(10) Pub. No.: US 2019/0367381 A1
(43) Pub. Date: Dec. 5, 2019

(54) Self cleaning solids liquid separation & water recycling apparatus

(71) Applicant: Lynn Allan Buckner, Flintstone, GA (US)

(72) Inventor: Lynn Allan Buckner, Flintstone, GA (US)

(21) Appl. No.: 16/501,623

(22) Filed: May 13, 2019

Related U.S. Application Data
(60) Provisional application No. 62/762,993, filed on May 29, 2018.

(51) Int. Cl. C02F 1/00; B01D 46/00

(52) U.S. Cl. CPC C02F 1/001; C02F 2103/10; B01D 46/0075

(57) ABSTRACT

A capsule plenum apparatus which: functions as a self cleaning filter and an apparatus for supplying a sufficient blend of cleaned recycled water and fresh water for the suction demands of a positive displacement water pump. The capsule plenum apparatus may include a vibrating filter apparatus with a self cleaning backwash apparatus and may be disposed within a hydro cyclone for the purpose of separating solids from a liquid before the recycled liquid enters the capsule plenum apparatus.

### BACKGROUND OF THE INVENTION

### Field of the Invention

The present invention relates to an apparatus for assisting in the recycling of water. One application for the present invention is to couple it with a hydro-vacuum excavation machine (such a the hydro-vacuum excavation machine with a solids/liquid separator apparatus disposed within the vacuum container U.S. Pat. Nos. 6,453,584 and 6,988,568 owned by the current inventor) for the purpose of reusing water that has been vacuumed up from such activities as horizontal boring operations, pot holing, surface cleaning; sewer line jettering operations; environmental chemical spills, a creek, a mud hole or the like.

The present invention includes a capsule plenum apparatus, and the capsule plenum apparatus may be at least partially submerged within a liquid which has entered into a hydro cyclone from a vacuum container via a pump apparatus. The capsule plenum apparatus has a filter for filtering water in from the hydro cyclone water supply while leaving solids on the hydro cyclone side of the filter. (the vacuumed/hydro cyclone water is considered to be recycled water).

The capsule plenum apparatus is responsible for; removing solids from recycled water; supplying the recycled water to the suction inlet a positive displacement water pump; determining if the volume of recycled water is sufficient to meet the suction inlet needs of said positive displacement water pump; adding supplemental fresh water to the suction inlet of said positive displacement water pump as needed; back flushing the capsule plenum apparatus filters.

The current invention is an efficient, self cleaning, apparatus for separating solids from liquid and includes a means of recycling cleaned water back to a point of reuse.

### Description of the Prior Art

Current state of the art hydro-excavation machines, surface cleaners and sewer jetting machines use water for their operation but discard the water to the environment as it is used. The current state of the art method does not recycle water back to a point of reuse.

### SUMMARY OF THE INVENTION

An apparatus and method for recycling water that is being used for a hydro-vacuum excavation operation. U.S. Pat. Nos. 6,453,584 and 6,988,568 owned by the current inventor accomplish the separation of solids from a liquid within a vacuum container of a hydro-vacuum excavation operation and also allows for the recycling of that liquid. However, in some cases there is a need to remove even more small solids from the recycled water after it leaves the vacuum container. This patent addresses that need with simple rugged apparatus to reliably achieve the removal of small solids from recycled water before it is supplied to the suction side of a positive displacement pump.

The shortcomings and disadvantages of the prior art are overcome by the present invention because the present invention provides an apparatus and method of separating liquid from solids at a rate similar to the rate at which water is being used by a hydro-excavator, surface cleaner or jetter. The present invention has a self cleaning feature which occurs simultaneously and as a function of the solids liquid separation process. The present invention removes sufficient quantities and sizes of solids in order to allow the residual liquid to be of a sufficient quality for reuse by positive displacement pumps and spray nozzles orifices which may be a part of a hydro-excavation, surface cleaning or jettering apparatus.

It is an object of the present invention to provide a capsule, being a container serving as a receptacle; wherein a portion of the capsule wall is porous, and at least the porous portion of said capsule is submerged within a body of liquid.

Another object of this invention is to have a vibrator means of moving said capsule within said body of liquid. A vibrating means of moving said capsule within said body of water may be a mechanical vibrator; a mechanical linkage system; a cam; an ultra sonic sound wave or the like. The movement of the filter portion of said capsule within said body of water may serve as a means of cleaning solids from the porous portion of said capsule.

Another object of this invention is to have a conduit means of transporting a liquid from within said capsule to a useful function outside of said capsule.

Another object of this invention is to have a conduit means of transporting a liquid into said capsule; said water being transported into said capsule may be a fresh make up water which may be used for backwashing said porous walls of said capsule.

Another object of this invention is to have a conduit means of transporting a liquid into said capsule; said liquid being transported into said capsule may be a fresh water make up which may be used as a supplemental source of water in the event that water entering said capsule through said porous walls is not sufficient to meet the needs of an external demand for water.

Another object of this invention is to have a means flexible means for supporting said capsule within said body of water. In order for said capsule to be moved of vibrated it needs a flexible means of support such as a cable; spring; shock or the like.

Another object of this invention is to remove cleaned water from a solids infested tank of water via a capsule which is totally and or partially submerged within the solids infested tank of water and the capsule also having a portion of porous walls which are submerged within the solids infested body of water. (Note: solids infested water describes any liquid which has a solid particle suspended within it which is also a water & solids mixture) The capsule forces solids to remain in the solids infested tank of water while simultaneously removing water less the solids through the porous walls of the capsule. The porous walls of the capsule may be removable screen wire having a predetermined orifice size or the porous wall may be holes placed in a surface or a woven substance or the like. The capsule also serves as a plenum for water being supplied to the suction of a pump. The capsule also serves as a means of supplying self cleaning techniques to the porous portion of the capsule.

Another object of this invention is for the capsule to serve as a self cleaning water pump suction supply plenum for managing and supplying a sufficient combination of recycled and fresh water to the suction demands of a water pump.

Another object of this invention is to supply pumps for moving water, controls for managing the operation, data gathering means of documenting what has happened and when it happened and where it happened, and an energy source for powering the operation.

Another object of this invention is to position the invention on a mobile devise such as a truck, trailer or skid.

Another object of this invention is to combine it with a vacuum container whereby the vacuum container is used for vacuuming up water that has been used for various operations such as hydro-excavation, surface cleaning, sewer jettering, environmental cleanup and the like.

Prominent features of the present invention have been broadly outlined above in order that the detailed description that follows may be understood. There are additional features of the invention that will be described hereinafter and which will add to the subject matter of the claims appended hereto.

### BRIEF DESCRIPTION OF THE DRAWINGS

FIG. 1 Is a side elevation view of the solids/liquid separation capsule flexibly suspended is a volume of water and solids mixture which is being pumped through a hydro cyclone apparatus as the water is being cleaned of solids as it flows to a water pump which supplies water pressure to a water nozzle.

FIG. 2 Is a top view of the solids/liquid separation capsule flexibly suspended is a volume of water and solids mixture which is being pumped through a hydro cyclone apparatus as the water is being cleaned of solids as it flows to a water pump which supplies water pressure to a water nozzle. A side elevation of a vacuum apparatus which vacuums up a solids/liquid mix is also illustrated.

### DETAILED DESCRIPTION OF THE PREFERRED EMBODIMENTS

Using the drawings, illustrations of the present invention will now be explained.

Definition for a filter: A device or a mass of material with openings through which a liquid is passed to remove something. A material that has holes and is used to separate out solid particles contained in a liquid that is passed through it. A porous device for removing impurities or solid particles from a liquid passed through it.
Definition for a hydrocyclone: A hydro cyclone is a static device that applies centrifugal force to a flowing liquid mixture so as to promote the separation of heavy and light components. The classic hydro cyclone is a vessel designed to convert incoming liquid velocity into rotary motion for the purpose of separating solids from the liquid.
Definition for a Capsule: A capsule for the purpose of this patent is a container for containing a volume of water, and having at least a porous section of side wall, a water inlet conduit and a water outlet conduit.
Definition for porous: having spaces or holes through which water may pass.

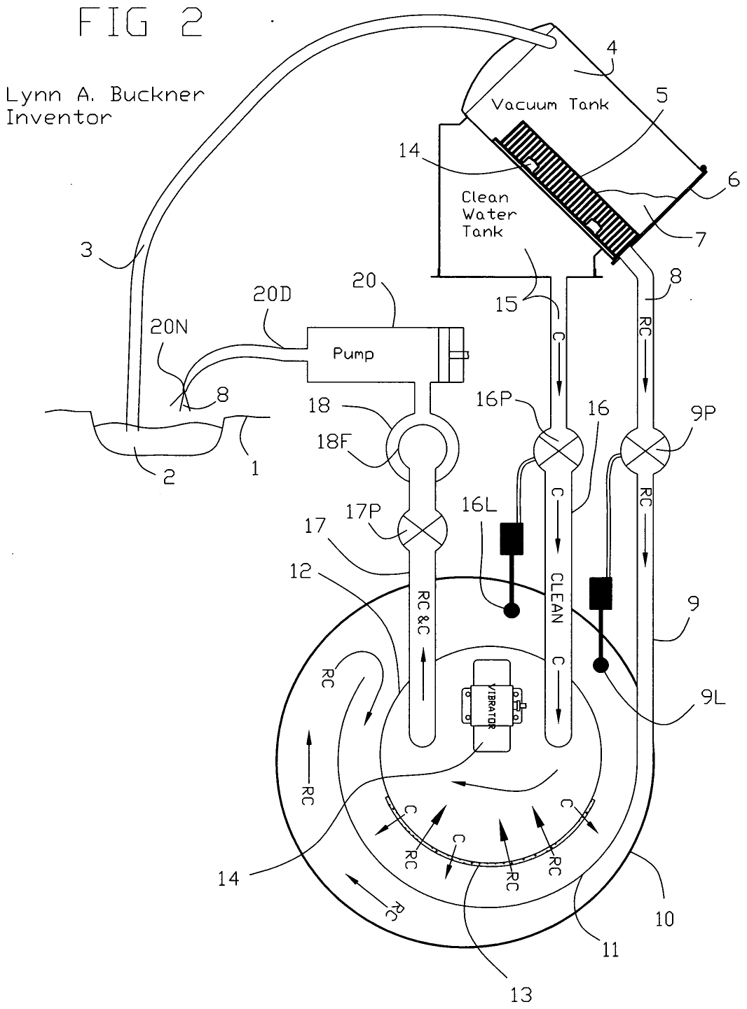

FIG. 2 illustrates a side view of a vacuum apparatus 4 having a vacuum hose 3 which is shown to be vacuuming up a volume of dirty water 2 which could be the result of hydro excavation, surface cleaning, sewer jetting or the like from the earth 1. A filtering screen 5 is shown to be located within the vacuum apparatus 4 tank. A vibrator 14 is shown as a means for improving the efficiency of the filtering screen 5. The filtering screen 5 is illustrated as leaving solids 7 within the vacuum apparatus 4 tank. The vacuum apparatus 4 tank is illustrated as having a door 6 for removing solids 7 from the vacuum apparatus 4 tank. Recycled water 8 is illustrated as passing through the filtering screen 5. Conduit 9 is illustrated a transporting the recycled water 8 to a hydro cyclone 10. A pump 9P is illustrated as pumping the recycled water 8 from the vacuum apparatus 4 to the hydro cyclone 10 under pressure via conduit 9. Pump 9P is illustrated as having controls 9L for controlling the functionality of pump 9.

A baffle 11 located within the hydro cyclone 10 will assist in the efficient flow of the recycled water 8 as it continues on a flow path to the capsule/container 12 which is flexibly suspended in the recycled water 8 which is flowing through the hydro cyclone 10.

The recycled water 8 enters the hydro cyclone 10 under pressure and the pressure forces the recycled water 8 against the outer wall of the hydro cyclone 10 as a centrifugal force. The centrifugal force aids in separating solids from liquid thus reducing the size and quantity of solids left in the recycled water 8. The hydro cyclone 10 with the aid of a baffle 11 causes heavier solids to settle to the bottom of the hydro cyclone 10 and floatable substances to float to the top surface of the recycled water 8. The flexibly mounted container 12 has a filter 13 which is positioned below the surface of the recycled water 8 that is in the hydro cyclone 10 thus floating solids are located above the container capsule 12, filter 13.

Recycled water 8 flows from the hydro cyclone 10 inlet to the capsule 12 filter 13. solids that are to large to pass through the capsule 12 filter 13 remain on the hydro cyclone 10 side of filter 13. recycled water 8 with even smaller sized solids flow through filter 13 and into capsule 12.

Recycled water 8 that has entered capsule 12 then flows to the capsule 12 water outlet conduit 17. Water outlet conduit 17 transports recycled water 8 from the capsule 12 to a water pump 20. Water pump 20 supplies recycled water 8 to a water nozzle 20N via conduit 20D. Water pump 20 is often a piston style pump for producing significant pressures however any water pump that pumps water under pressure may be substituted for the piston water pump 20.

Conduit 17 may also pass the recycled water 8 through a water pump 17P for busting water pressure as it leaves capsule 12. The water pump 17P may also be used for pressurizing the recycled water 8 so that the recycled water 8 may be forced through a bag filter 18 which contains a filter 187 for removing even smaller size solids from the recycled water before the recycled water 8 enters the piston water pump 20.

Capsule 12 has an inlet conduit 16 for supplying clean water 15 into capsule 12. A pump 16P may be added for the purpose of increasing the pressure of the clean water 15 as it enters capsule 12. Controls 16L monitor and control the functionality of adding clean water 15 to capsule 12.

Clean water 15 is added to capsule 12 as needed to supplement the recycled 8 water needs of piston pump 20.

For a period of time clean water 15 may be added to capsule 12 at a flow rate in excess of the needs of piston pump 20. The excess volume flow of clean water 15 into capsule 12 will cause a portion of the fresh water 15 to flow through capsule 12 filter 13, thus back washing capsule 12 filter 13.

The excess volume flow of clean water 15 into capsule 12 and through filter 13 as back wash will also aid in maintaining a predetermined level of liquid within the hydro cyclone 10.

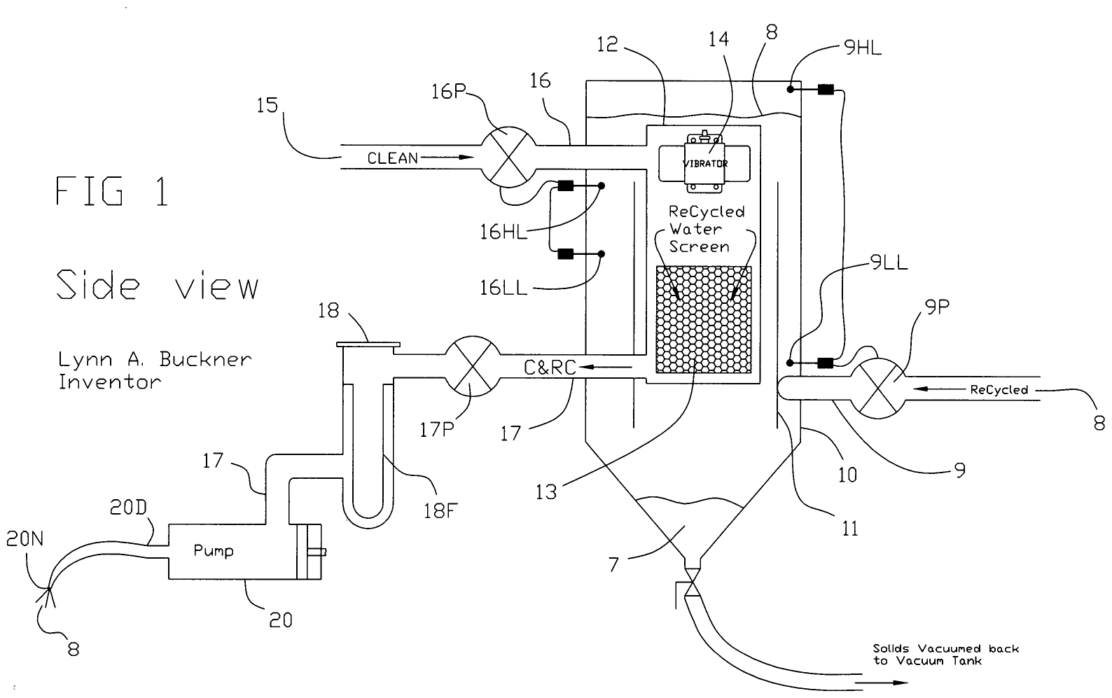

A vibration apparatus 14 may be added to capsule 12 for the purpose of cleaning solids from capsule 12 filter 13. The vibration apparatus 14 may be any method that gives movement to the filter 13 in relation to the body of water it is suspended in. The movement may be a churning action a vibrator, an ultra sonic wave or the like. FIG. 1 is a side view similar to FIG. 1 in functionality. The vacuum apparatus is not shown in FIG. 1.

The preceding description has been presented only to illustrate and describe an example of the invention. It is not intended to be exhaustive or to limit the invention to any precise form disclosed. Many modifications and variations are possible in light of the above teaching.

The illustrations were chosen and described in order to explain the principles of the invention and its practical application. The preceding description is intended to enable others skilled in the art to utilize the invention in various embodiments and with various modifications as are suited to the particular use contemplated. It is intended that the scope of the invention be defined by the following claims.

1. A self cleaning apparatus for separating solids from liquid water comprising: a container, and said container further comprises side walls, wherein a portion of said side wall is a filter apparatus and said filter apparatus further comprises a vibrator apparatus; wherein said container further comprises an inlet conduit for transporting fresh makeup water into said container, and said container further comprising a dispensing conduit for dispensing liquid water from said container; wherein said container is at least partially submersed in a volume of solids/liquid mixture; whereby said filter portion of said side wall may be submerged within a volume of liquid water, solids and or dirt mixture and said filter portion of said container side wall may pass liquid water through said filter while restricting said solids and or said dirt from passing through said side wall filter and whereby said inlet conduit may transport fresh makeup water into said container and then pass a portion of said fresh makeup water through said filter portion of said side wall thus back washing said filter portion of said side wall as said fresh makeup water is added to said liquid, solid or dirt mixture; whereby said vibrating action may minimize the adhering of said solids and or dirt to said filter portion of said side wall.

2. An apparatus comprising; a container for holding a volume of solids infested liquid and a capsule, wherein said capsule is at least partially submerged within said solids infested liquid; wherein said capsule further comprises an inlet conduit; an outlet conduit; side walls, wherein a portion of said side walls are porous; a vibrator, wherein said vibrator is adjacently attached to said capsule; whereby said porous portion of said capsule side wall may pass a liquid through it while restricting a solid from passing through said porous side wall, and said vibrator may cause said capsule to move within said volume of solids infested liquid, thus washing said solids from said porous portion of said capsule and said inlet conduit may transport a fresh make up liquid into said capsule and then pass a portion of said fresh makeup water through said porous portion of said side wall thus back washing said porous portion of said side wall as said fresh makeup water is added, and said outlet conduit may transport a mixture of filtered and fresh water from within said capsule to a useful operation.

4. The apparatus as described in claim 2 wherein said capsule is flexible mounted to said container, whereby said capsule may be positioned to a predetermined depth within the solids infested water.

5. The apparatus as described in claim 2 and further comprising a pump for assisting in the transport of make water into said capsule.

6. The apparatus as described in claim 2 and further comprising a pump for assisting in the transport of water from within said capsule to a useful operation.

7. The apparatus as described in claim 2 and further comprising a pump for supplying solids infested water to said container.

8. The apparatus as described in claim 2 and further comprising controllers, whereby said controllers manage the functionality of said apparatus.

9. The apparatus as described in claim 2 and further comprising a data collection system, whereby said data collection system documents what, when, and where each function of said apparatus occurred.

10. The apparatus as described in claim 2 and further comprising an energy source for powering pumps, vibrators, controls and data management.

11. A self cleaning method for separating solids and or dirt from liquid water, implemented by an apparatus which comprising the steps of:
Providing a container for containing a mixture of solids and liquid water:
providing a capsule for collecting filtered liquid water through a filter apparatus;
providing a vibrator for vibrating said filter for the purpose of minimizing the adhering of said solids and or dirt to said filter;
providing said capsule with a first conduit for the purpose of supplying fresh makeup water to said capsule;
providing said fresh makeup water to said capsule with sufficient volume and pressure so as to flow said makeup water through said filter and into said mixture of solids liquid water so as to also backwash said filter.
providing a second conduit for the purpose of dispensing said filtered water and or said make up water from said capsule.
